(19) United States
(12) Patent Application Publication
(10) Pub. No.: US 2017/0212606 A1
(43) Pub. Date: Jul. 27, 2017

(54) DISREGARDING INPUT PROVIDED BY A SOURCE OTHER THAN THE USER

(71) Applicant: Lenovo (Singapore) Pte. Ltd., Singapore (SG)

(72) Inventors: Timothy Winthrop Kingsbury, Cary, NC (US); Russell Speight VanBlon, Raleigh, NC (US); Joaquin F. Luna, Durham, NC (US); Scott Wentao Li, Cary, NC (US); Robert James Kapinos, Durham, NC (US)

(21) Appl. No.: 15/006,903

(22) Filed: Jan. 26, 2016

(51) Int. Cl. G06F 3/038; G06K 9/00

(52) U.S. Cl. CPC G06F 3/038; G06K 9/00335; G06K 9/00355

(57) ABSTRACT

One embodiment provides a method including: monitoring, using a processor, a position of a user; receiving, from an input device, input; determining, based on the monitoring, that the input was provided by a source other than the user; and disregarding, using a processor, the input. Other aspects are described and claimed.

### BACKGROUND

Information handling devices (e.g., smart phones, tablets, laptop computers, etc.) allow a user to provide input using a variety of input devices, for example, conventional keyboards, soft keyboards, touch screens, mice, and the like. The changing nature of information handling devices, for example, increased portability, increased input options, and the like, allow users to provide input to the devices in unconventional locations which are not always secluded from other input sources.

### BRIEF SUMMARY

In summary, one aspect provides a method, comprising: monitoring, using a processor, a position of a user; receiving, from an input device, input; determining, based on the monitoring, that the input was provided by a source other than the user; and disregarding, using a processor, the input.

Another aspect provides an information handling device, comprising: at least one input device; a processor operatively coupled to the at least one input device; a memory device that stores instructions executable by the processor to: monitor a position of a user; receive, from the at least one input device, user input; determine, based on the monitoring, that the input was provided by a source other than the user; and disregard the input.

A further aspect provides a product, comprising: a storage device that stores code executable by a processor, the code being executable by the processor and comprising: code that monitors a position of a user; code that receives, from at least one input device, user input; code that determines, based on the monitoring, that the input was provided by a source other than the user; and code that disregards the input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of disregarding input provided by a source other than the user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The nature and form factor of information handling devices has evolved to result in information handling devices being located and accessible from many locations. For example, information handling devices have become very common in many households. This results in situations in which errant input can be provided to the device that are uncommon in other environments (e.g., a work environment, etc.). For example, a pet (e.g., dog, cat, ferret, etc.) may walk across the keyboard connected to a device, thereby causing errant input into an application that a user may have open on the computer.

Additionally, the portability of devices allows a user to use the device in many locations, not all being set up for use of a device or being free from other users. For example, a user may use their laptop in their recliner chair. The issue with this is that other sources can provide unintentional input because the location is not secluded or properly set up for using devices and their input sources (e.g., mouse, keyboard, etc.). For example, a user may drop their mouse which results in multiple buttons being pushed and possibly selecting objects within applications that the user did not intend to select.

Additionally, due to the increase in devices that have touch screens or other touch enabled inputs (e.g., track pad, soft keyboards, etc.) the ability of another person to provide accidental input has increased. For example, a second user may be pointing to something on a touch screen and accidentally touch the screen causing the application or device to perform an unintended or unwanted action.

These technical issues present problems for users in that identifying and disregarding input which was not intended by the primary user may be difficult. Currently devices accept all input that is provided by to the device regardless of the user or whether the user actually intended to provide the input. Accepting all input can result in the user having to remove the unwanted input. For example, if a user's cat walks across the keyboard while the user is typing, the user will have to select all the errant text and remove it from the document that user is typing in. Additionally, accepting input can cause the system to perform unwanted actions that can be difficult to reverse or fix. For example, a second user may accidentally touch a touch screen causing the application to close without saving the user's work. This may result in the user having to recreate the work or spend time trying to recover the document.

Accordingly, an embodiment provides a method of disregarding input provided by a source other than the user. An embodiment may monitor the position of a user, particularly, the position of the user as associated with the hands of the user. As an example, an embodiment may use an image capture device (e.g., camera, video recorder, infrared image capture device, etc.) to identify where the user's hands are positioned (e.g., two hands on a keyboard, left hand on a mouse, one hand not in proximity to an input device, etc.). Another embodiment may use proximity sensors to determine the position of the user. These proximity sensors may indicate the placement of the user's hands with respect to the input devices. Another embodiment may use a timing or contextual based approach to monitor the position of the user.

An embodiment may then receive input from an input device. Based upon the monitoring of the position of the user, an embodiment may determine that the input was provided by a source other than the user. For example, an embodiment may identify that a user has provided input using two hands to a keyboard and then may receive input to a touch screen. Based upon the timing of the inputs, an embodiment may be able to identify that a user could not have provided all three inputs. As another example, an embodiment may identify that a user has one hand on the mouse and one hand on the left side of the keyboard. Upon receiving input from the right side of the keyboard, an embodiment may identify that the user could not have possibly provided the input to the right side of the keyboard from the position of the left hand or the position of the hand on the mouse. Upon determining that the input was provided by a source other than the user, an embodiment may disregard the input. One embodiment may also request that the user confirm that the input should be disregarded.

The illustrated example embodiments will be best understood by reference to the figures. The following description is intended only by way of example, and simply illustrates certain example embodiments.

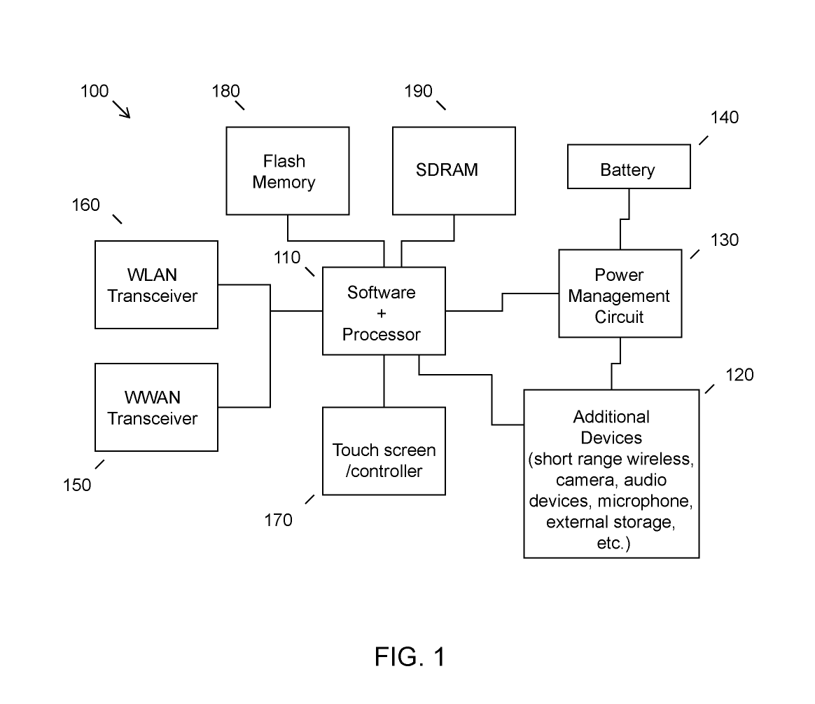

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image capture device such as a camera, proximity sensors, and the like. System 100 often includes a touch screen 170 for data input and display/rendering. System 100 also typically includes various memory devices, for example flash memory 180 and SDRAM 190.

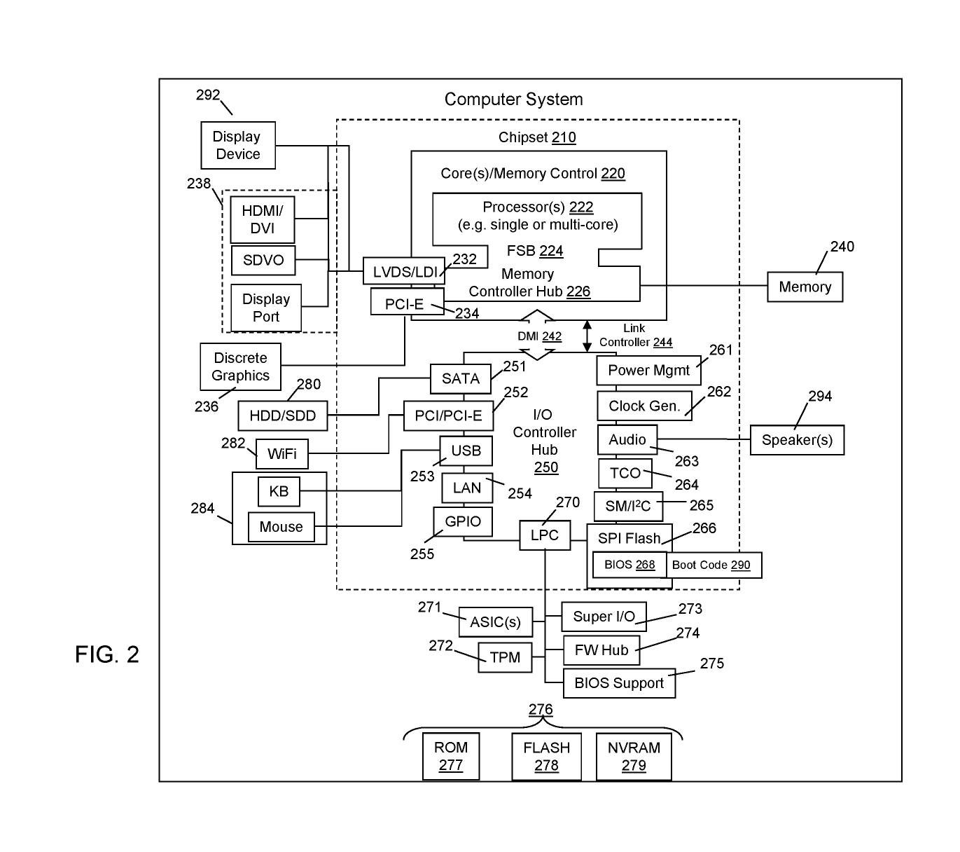

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to create documents, create spreadsheets, execute applications, and the like, for which input is necessary. For example, the circuitry outlined in FIG. 1 may be implemented in a tablet or smart phone embodiment, whereas the circuitry outlined in FIG. 2 may be implemented in a personal computer embodiment.

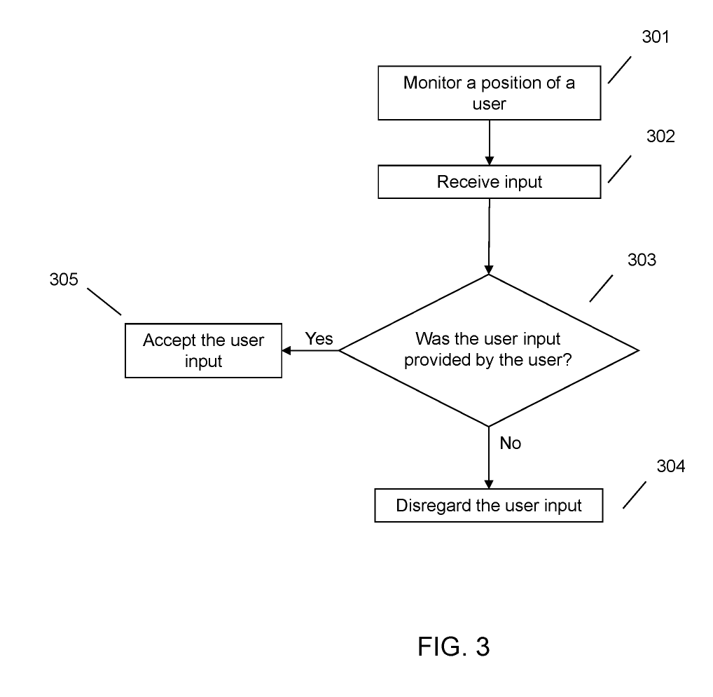

Referring now to FIG. 3, at 301, an embodiment may monitor a position of a user. In one embodiment, the position of the user may include whether the user is facing the device. For example, an embodiment may detect that a user's shoulders are turned from the device, which may indicate that the user is not providing input to the device. As another example, an embodiment may identify whether the user is facing the device In one embodiment, the position of the user may be associated with the hands of the user. For example, an embodiment may monitor the user's hands or other body part which may indicate the location of the user's hands. For example, an embodiment may monitor the movement of the user's arm to determine the position of the user's hand or hands. An embodiment may monitor the position of the user with respect to one or more input devices of the device. For example, an embodiment may determine where the user's hands are located with respect to the touch screen of the device to determine if the user is touching the touch screen with one or both hands. Additionally, an embodiment may identify a more precise location of the user's hands with respect to the input device. For example, an embodiment may identify that the user's left hand is touching a mouse and the user's right hand is over the number pad of a keyboard.

Monitoring the position of the user may include using one or more image capture devices or sensors to identify where the user's hands are located with respect to an input device. For example, a camera may be mounted on the display portion of the device to capture the user's hands on the keyboard, mouse, touch pad, or other input device. The image capture device does not have to be co-located with the device. Rather, the image capture device or sensor can be located in a different location and communicate with the device. For example, a video camera may be mounted on a wall in a room where a device is located. The video recorder may then capture information related to whether the user is facing the device or not. The device may be able to communicate with this video camera to identify the position of the user.

In another embodiment, the position of the user may be identified using one or more proximity sensors. The proximity sensors may be located on the input device. As an example, proximity sensors may be located on a keyboard to indicate that an object is located on or near the keyboard. More than one proximity sensor may be used to further delineate the position of the user. For example, each key may include a proximity sensor to identify not only the position of a user's hands but also the position of a user's fingers. This may assist in identifying how many hands are touching any of the input devices at a particular time.

One embodiment may use a time or context based method of monitoring the position of the user. For example, a user may be providing input from the mouse and the keyboard, so an embodiment may extrapolate the position of the user. For example, if a user is providing a mouse input and a keyboard input within a particular time threshold, which may be a default value or adjusted by a user, an embodiment may identify that the user cannot also provide a touch input in the same time frame, because it would require three hands to provide all these inputs. As another example, an embodiment may identify that the input provided is associated with keys on the left side of the keyboard and also input from the touch screen. Therefore, the system may conclude that the user has one hand on the left side of the keyboard and one hand on the touch screen.

At 302, an embodiment may receive input from an input device. The input device may be any device connected or operatively coupled to the device that a user can use to provide input. Example types of input devices include standard keyboards, touch enabled devices, soft keyboards, mouse input, and the like. For example, an embodiment may receive touch input from a touch enabled device (e.g., touch pad, touch screen, etc.) that requests an action be performed (e.g., the mouse is moved, words are selected, characters are entered, etc.). As another example, an embodiment may receive character input from a keyboard or mouse movement from a mouse. The input may also include input to buttons on the device. For example, input may include pressing the power button, adjusting the volume level, enabling a network device, and the like.

At 303, an embodiment may determine, based upon the position of the user, whether the input was provided by a source other than the user. For example, an embodiment may identify that both of the user's hands are located on the keyboard and that the received input was from the mouse. Thus, an embodiment can determine that the user likely did not provide the mouse input. As another example, using the image capture device, an embodiment may identify that a third hand provided touch input. Thus, an embodiment can determine that the touch input was likely not provided by the primary user. As another example, using the proximity sensors an embodiment may have identified that a user has one hand on the keyboard and one hand on the mouse. Upon receiving a touch pad input, the system may determine that the user likely did not provide that input because the user's hands are still on the keyboard and the mouse.

Another method for determining whether the input was provided by the user is to use context associated with or a characteristic of the input. For example, if a user has been providing input on the left side of the keyboard and the mouse, and input is provided on the right side of the keyboard, an embodiment may determine that the input from the right side of the keyboard was likely not provided by the user. An embodiment may determine this because it may not be physically possible to provide input from the left side of the keyboard to the right side of the keyboard. An embodiment may also determine this based upon the timing associated with the input at the right side of the keyboard. For example, if the user is providing input from the left side of the keyboard and the input from the right side of the keyboard is received at substantially the same time, the system may identify that the user could not have provided this input if the user's right hand is located on the mouse.

Another method of determining whether the input was provided by the primary user is to identify the input that was received. For example, if a user is typing on a keyboard in a typical document and input is received that comprises random keys that do not form a word, an embodiment may flag this input as possibly not being provided by the user. An additional example is if multiple keys are pressed at the same time repeatedly. For example, if a cat was walking across the keyboard the cat will likely not only press a single key at a time. Therefore, the system may flag the random multiple key strikes as possibly unintended input.

The system may also use additional sensors to determine whether the input is provided by the primary user. For example, an embodiment may include pressure sensors that have been trained to a specific user. In receiving input exceeding the expected pressure, an embodiment may flag the input as unintended input. For example, using the example of the pet walking across the keyboard, when the pet presses the keys these key presses may be at a greater pressure than a user typing. The system may also compare the input to a setting or history of input for the user. For example, the system may include a setting that indicates if a certain number of random inputs are received then the input should be disregarded. As another example, the system may identify that the user has been providing input through the number pad and touch screen. When input is provided from the left side of the keyboard, the system may flag this as unintended input because the user has not been providing input from this location on the keyboard.

If the system determines, at 303, that the input was provided by a source other than the user, the system may disregard the input at 304. In disregarding the input the system may not perform the action associated with the input received. For example, if the input comprised typing characters, the system may not accept or enter the characters. As another example, if the input comprised deleting a document, the system may not perform the actions associated with deleting the document. Disregarding the input may also comprise reversing an action caused by the input. For example, if the input was to close an application, the system may reopen the application. As another example, an embodiment may receive input to the power button of the device and identify that the primary user did not provide this input and would thus not power off or hibernate the device.

Additionally, an embodiment may request verification from a user that input should be ignored. For example, the system may provide a prompt requesting the user to confirm that the previously entered input should be ignored. The system may, alternatively, provide a prompt to the user informing the user that input was disregarded. Alternatively, an embodiment may receive input and ask the user if they intended to provide input. For example, if a user provides input that the system has flagged as not provided by the user, the system may prompt the user to verify whether they actually intended to provide the input.

In some cases the system may not be able to determine whether the user or another source provided the input. In other words, the source of the input is ambiguous. If the system cannot determine which input has been provided by the primary user, an embodiment may disregard all the input. For example, if the provision of the input is ambiguous, but the system can identify that the user could not have provided all the input, the system may disregard all the received input. Alternatively, the system may request confirmation from the user of which input should be disregarded or accepted.

If, however, the system, at 303, determines that the input was provided by the user, then the system may accept the user input at 305. In other words, the system may perform the action associated with the received input.

The various embodiments described herein thus represent a technical improvement to systems in that inadvertent input can be disregarded by the system. Using the techniques described herein, the system can monitor the position of a user and determine when input is provided by a source other than a user and disregard this errant input. Thus, a user is prevented from having to fix any issues that arise when errant input is accepted.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
monitoring, using a processor, a position of a user;
receiving, from an input device, input;
determining, based on the monitoring, that the input was provided by a source other than the user; and
disregarding, using a processor, the input.

2. The method of claim 1, wherein the monitoring comprises monitoring the position of a user using an image capture device.

3. The method of claim 1, wherein the determining comprises identifying that a third hand provided the user input.

4. The method of claim 1, wherein the monitoring comprises monitoring the position of a user using a proximity sensor.

5. The method of claim 1, wherein the position of a user is associated with hands of the user.

6. The method of claim 1, wherein the determining comprises comparing at least one characteristic of the user input to at least one characteristic of previous input provided by the user.

7. The method of claim 6, wherein the at least one characteristic comprises a position on the input device of the user input.

8. The method of claim 1, wherein the determining comprises determining that the user input comprises input inconsistent with the position of a user.

9. The method of claim 1, wherein the receiving is received from an input device selected from the group consisting of: a keyboard, a mouse, and a touch enabled device.

10. The method of claim 1, further comprising requesting verification from the user that the user input should be disregarded.

11. An information handling device, comprising:
at least one input device;
a processor operatively coupled to the at least one input device;
a memory device that stores instructions executable by the processor to:
monitor a position of a user;
receive, from the at least one input device, user input;
determine, based on the monitoring, that the input was provided by a source other than the user; and
disregard the input.

12. The information handling device of claim 11, wherein the instruction executable by the processor to monitor comprises an instruction to monitor the position of a user using an image capture device.

13. The information handling device of claim 11, wherein the instruction executable by the processor to determine comprises an instruction to identify that a third hand provided the user input.

14. The information handling device of claim 11, wherein the instruction executable by the processor to monitor comprises an instruction to monitor the position of a user using a proximity sensor.

15. The information handling device of claim 11, wherein the position of a user is associated with hands of the user.

16. The information handling device of claim 11, wherein the instruction executable by the processor to determine comprises an instruction to compare at least one characteristic of the user input to at least one characteristic of previous input provided by the user.

17. The information handling device of claim 16, wherein the at least one characteristic comprises a position on the input device of the user input.

18. The information handling device of claim 11, wherein the instruction executable by the processor to determine comprises an instruction to determine that the user input comprises input inconsistent with the position of a user.

19. The information handling device of claim 11, wherein the input device is selected from the group consisting of: a keyboard, a mouse, and a touch enabled device.

20. A product, comprising:
a storage device that stores code executable by a processor, the code being executable by the processor and comprising:
code that monitors a position of a user;
code that receives, from at least one input device, user input;
code that determines, based on the monitoring, that the input was provided by a source other than the user; and
code that disregards the input.
